(19) United States
(12) Patent Application Publication
(10) Pub. No.: US 2005/0174946 A1
(43) Pub. Date: Aug. 11, 2005

(54) System and method of implementing a digital emulator for a digital central office

(76) Inventor: David M. Smith, Plano, TX (US)

Correspondence Address: MICHAEL L. DIAZ, P.C., 555 REPUBLIC DRIVE, SUITE 200, PIANO, TX, 75074, US

(21) Appl. No.: 11/025,298

(22) Filed: Dec. 29, 2004

Related U.S. Application Data
(60) Provisional application No. 60/533,058, filed on Dec. 29, 2003.

(51) Int. Cl. H04L 12/26

(52) U.S. Cl. 370/241

(57) ABSTRACT

The present invention is a system and method of providing a GR303 interface to a digital central office. A virtual line group is installed within a line frame holding a plurality of line groups for communicating with analog subscriber telephones. The digital central office utilizes internal proprietary signals to operate the line groups and route calls to a public switched telecommunications network. The virtual line group emulates a line group within the digital central office and provides an GR303 interface for communicating with remote digital loop carriers. The virtual line group provides the GR303 interface without modifying or adding software or hardware to the digital central office.

### RELATED APPLICATIONS

This utility application claims the priority date of Provisional Patent Application Ser. No. 60/533,058 filed Dec. 29, 2003 and is hereby incorporated by reference.

### BACKGROUND OF THE INVENTION

1. Field of the Invention

This invention relates to telecommunications. Specifically, the present invention relates to a system and method of implementing a digital emulator for a digital central office.

2. Description of the Related Art

A class 5 central office comprises a building or room which houses a class 5 switching system, which operates to connect telephones and other devices used by end-user customers (“subscribers”) to a telecommunications network such as the public switched telephone network (“PSTN”). A class 5 digital switch also converts the analog signals used by telephones, modems, FAX machines, and some PBX trunks, into the digital signals that are routed through a digital telecommunications network. The class 5 digital switch also provides special services for caller ID displays and message waiting lights for subscribers, and it processes and routes calls from digital PBX trunks, ISDN lines, and digital loop carriers (“DLC”) to a telecommunications network.

One type of class 5 switch known as a digital central office is commonly employed in various telecommunication systems. Siemens manufacturers a digital central office called a DCO®, which provides an antiquated TR08 signaling protocol as an optional integrated DLC protocol. However, such digital central offices suffer from a significant disadvantage of not being able to use the industry standard signaling protocol GR303. GR303 is the technology of choice for deploying loop carrier equipment. GR303 provides features not available to digital switches using TR08. Specifically, GR303 is preferred over TR08 in existing telecommunications networks. In addition, many modern integrated DLCs do not support TR08. GR303 also allows variable concentration of subscriber lines and load-sharing of T1's not available in TR08.

In addition, the digital central office often deploys in a double-ended digital loop carrier (DLC) configuration, which requires the use of separate equipment, i.e., analog central office terminals (COTs). FIG. 1 is a simplified block diagram illustrating the components of an existing digital central office in a double-ended DLC configuration. A central office (CO) 10 communicates via T1 lines to a plurality of remote cabinets 12. In addition, the CO provides communications via 360 remote lines 14. To accommodate these lines, the CO must include a local line switch (LLS) with 60 dedicated private line cards 16 as well as three analog COTs 18. The use of these analog COTs is very expensive and increases the use of expensive floor space of the digital central office. Additionally, 56K dialup Internet service is not available, due to the extra digital/analog conversions in COTs 18 and the dedicated private line cards. Instead, the subscribers are forced to use slower 28.8K dialup Internet service.

To utilize GR303 in a digital class 5 switch, many manufacturers have started to manufacture class 5 switches incorporating the GR303 protocol. However, there are many existing digital switches, which do not use GR303, and the replacement of these existing digital switches would be extremely expensive. In addition, to modify these existing digital switches to utilize the GR303 protocol would involve substantial modifications to the software and hardware of the switches. Implementing these substantial modifications is just not cost-effective for the numerous existing digital switches. A system and method are needed which enables a digital central office to utilize GR303 without modifying the hardware or software of the digital central office. It would be advantageous to provide a virtual line group capable of utilizing the GR303 protocol which emulates an existing line group in the digital central office.

Thus, it would be a distinct advantage to implement the GR303 protocol into a digital central office class 5 digital switch without modifying its software or hardware. It is an object of the present invention to provide such a system and method.

### SUMMARY OF THE INVENTION

It is a primary object of this invention to provide a GR303 interface to a digital central office that is presently limited to TR08. Many DLCs require the use of GR303 and do not support TR08. Therefore, a cost-effective interface is required which enables an existing digital central office, such as the DCO® manufactured by Siemens, to interface with remote DLCs or other telecommunications nodes which only support GR303. The interface is incorporated within a virtual line group residing in a line frame of the digital central office. The virtual line group communicates with the digital central office in the same manner as an existing line group. The virtual line group provides the GR303 interface without modifying the existing software or hardware of the digital central office.

In one aspect, the present invention is a digital central office having a GR303 interface. The digital central office includes a line frame having a plurality of line groups and a virtual line group residing within the line frame. The digital central office also includes a common management frame communicating with the plurality of line groups and virtual line group using proprietary internal signals. At least one digital loop carrier communicates with the virtual line group using a GR303 signaling protocol. The virtual line group provides a GR303 interface for the digital central office.

In another aspect, the present invention is a virtual line group providing a GR303 interface to a digital central office. The virtual line group includes a processor for controlling the virtual line group and a timeslot interchange function for communicating with at least one digital loop carrier. The virtual line group may communicate with proprietary internal signals within the digital central office and communicates with the digital loop carrier using a GR303 signaling protocol.

In still another aspect, the present invention is a method of providing a GR303 interface to a digital central office that is limited to TR08. The method begins by providing a virtual line group to the digital central office. The digital central office also has a plurality of existing line groups. The virtual line group then emulates an existing line group within the digital central office. The virtual line group communicates with at least one digital loop carrier using a GR303 signaling protocol.

### BRIEF DESCRIPTION OF THE DRAWINGS

FIG. 1 (prior art) is a simplified block diagram illustrating the components of an existing digital central office in a double-ended DLC configuration;

FIG. 2 is a simplified block diagram of components of a local line switch (LLS) of a digital central office in the preferred embodiment of the present invention;

FIG. 3 is a simplified block diagram of a plurality of line frames connected to the SDLC loop in the preferred embodiment of the present invention;

FIG. 4 is a simplified block diagram of a virtual line group and a plurality of DLCs in the preferred embodiment of the present invention; and

FIG. 5 is a flow chart outlining the steps for digitally emulating a line group within a digital central office according to the teachings of the present invention.

### DESCRIPTION OF THE INVENTION

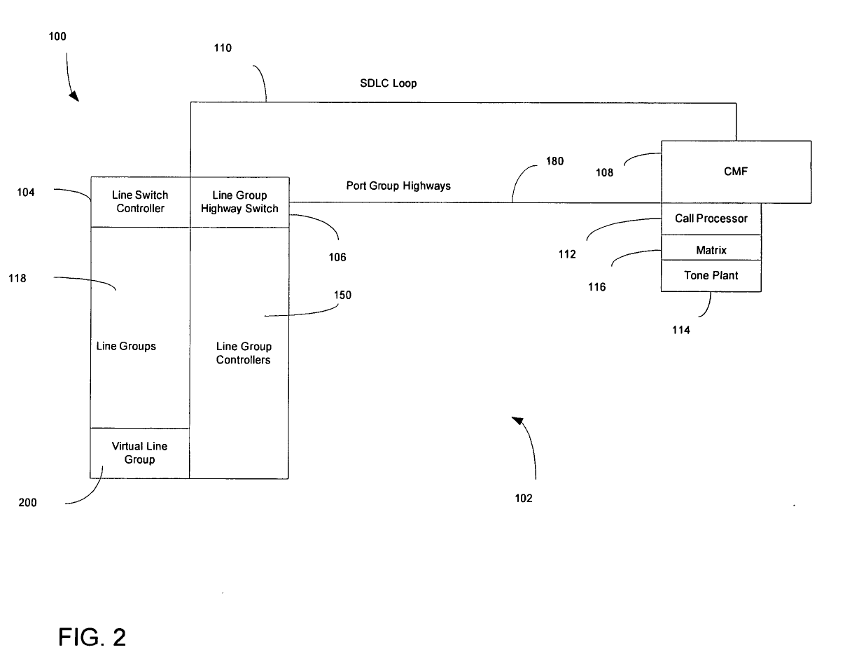

A digital emulator for a digital class 5 switch is disclosed. FIG. 2 is a simplified block diagram of components of a local line switch (LLS) 100 of a digital central office 102 in the preferred embodiment of the present invention. The digital central office utilizes TR08 without a GR303 capability. Siemens manufactures such a digital central office called a DCO®. The digital central office includes a line switch controller 104 and a line group highway switch 106. The line switch controller includes a microprocessor which communications with a common management frame (CMF) 108. The CMF includes a call processor 112, a tone plant 114, and a matrix 116. A synchronous data link control (SDLC) loop 110 provides a connection from the CMF to all the line frames of the digital central office.

A line group controller 118 controls a specific line group 150. Normally there are 12 line groups 150. Thus with 12 line groups, there are 12 line group controllers. Each line group can handle up to 90 lines. The line group controller includes a microprocessor, which communicates with the SDLC loop. The line group controller provides instructions to its associated line group.

The line group highway switch 106 communicates with the matrix 116 through one or more port group highways 180. The line group highway switch distributes data from the matrix to each line group via a line group highway 182. In addition, each line group also has a line group mux 184 that distributes pulse code modulation (PCM) data out to actual line cards in the line group.

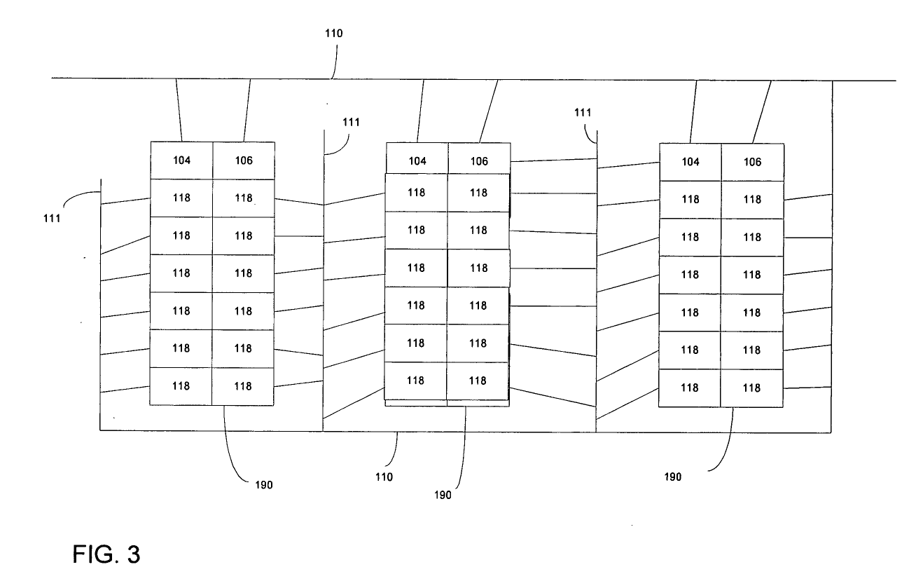

FIG. 3 is a simplified block diagram of a plurality of line frames 190 connected to the SDLC loop 110 in the preferred embodiment of the present invention. Each line group is also connected to a peripheral SDLC loop 111. Additionally, each line frame is connected to the SDLC loop 110. As discussed above, there is a plurality of line groups 118 in each frame. Although three line frames are illustrated, it should be understood that the number of line frames is illustrative only.

To enable the digital central office to utilize GR303, the present invention utilizes one or more virtual line groups 200 collocated with the other line groups within a line frame of the digital central office. The virtual line group is connected to the SDLC loop 110. In addition, in a similar manner as the line group 150, the virtual line group 200 is connected to the line group highway 182 via the line group highway switch 106. The virtual line group is mounted inside any available digital central office line group cell. In the preferred embodiment of the present invention, the virtual line group includes a TL1 command line interface for local and remote provisioning and alarm reporting. In addition, the virtual line group may optionally include grooming of non-switched special services (e.g., PBX tie trunks, internet data, etc.).

The virtual line group 200 performs the function of a line group 150 by receiving and sending PCM data and communicating with the various components of the digital central office. The virtual line group also provides a conversion between the internal proprietary signals for PCM data, etc., and the GR303 protocol. However, the virtual line group 200 also provides the additional functionality of communicating with remote lines to one or more DLCs 300.

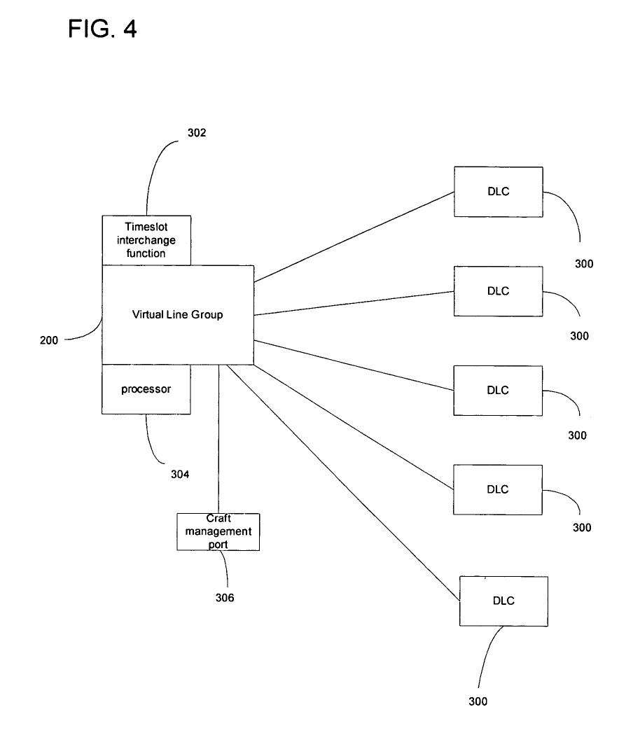

FIG. 4 is a simplified block diagram of a virtual line group 200 and a plurality of DLCs 300 in the preferred embodiment of the present invention. The virtual line group includes a timeslot interchange function 302 and a processor 304. Additionally, the virtual line group 200 includes a craft management port 306 allowing communication with a connected computer. The virtual line group communicates with one or more DLC's 300 utilizing the GR303 protocol.

Because GR303 does not associate different timeslots with different lines, the timeslot interchange function is required. In addition, a timeslot interchange function also allows switch ports associated with one line group to be distributed on different remote components of the system.

With the existing digital central office, TR08 allows 90 lines to one remote DLC, which cannot be broken up. For example, even if there are 30 subscribers, there would still be 90 lines allocated to these 30 subscribers. However, with the timeslot interchange function, multiple T1 lines may now go to different places, thereby providing more efficient allocation within the line group. The time slot interchange function 302 actually decouples remote DLC terminals from the physical line groups, thereby allowing the flexible allocation of lines to various subscribers.

As discussed above, T1 lines run from the DLC to the virtual line group 200. By utilizing the timeslot interchange function 302, a portion of the timeslots may be allocated to data separate from voice data. The timeslot interchange function provides a cross connect function which allows the use of timeslots which are piggybacked with voice data. Thus, a single T1 line may be used to carry both data and voice data, which prevents the necessity of utilizing a separate T1 line to carry the data.

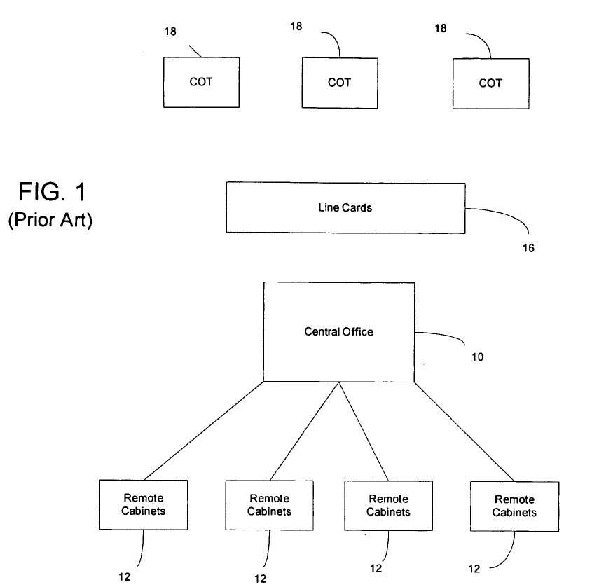

GR303 allows the use of less-expensive, single-ended DLCs, rather than double-ended DLCs discussed in FIG. 1. This also eliminates analog POTS interfaces in the CO. Unlike TR08, the fully digital interface of the virtual line group 200 supports 56K (V.90) dial-up modem access for subscribers.

GR303 protocol is also superior to TR08 protocol for several reasons. GR303 is used in an integrated DLC, which are commonly used in existing telecommunications networks. Most of these modern integrated DLCs do not support TR08. In addition, GR303 allows variable concentration of subscriber lines and load-sharing of T1's not available in TR08. In addition, the present invention allows integration of remote line switch (RLS) frames. The new class 5 switches being manufactured often do not even support TR08. Therefore, when new switches are fielded in a system, GR303 will already be used, thus facilitating the future transition to a new digital switch.

With reference to FIGS. 2-4, the operation of the present invention will now be explained. The digital central office 102 operates within a telecommunications network. Within the digital central office is a line switch controller 104 controlling a plurality of line groups 118. The line group 118 operates under the TR08 protocol, providing distinct disadvantages in comparison to GR303. Each line group is controlled by a specific line group controller. The line group controller communicates with the line switch controller and the line group highway switch 108. The line group high switch receives and sends information via one or more port group highways 180 to the CMF 108. The CMF utilizes a call processor 112, a matrix 116, and a tone plant 114. While communicating with the front end of the digital central office, the TR08 protocol is utilized.

The virtual line group 200 is positioned within an empty slot of the line frame of the digital central office. The virtual line group 200 communicates in the same manner as the other line groups 118 within the digital central office. However, in conjunction with the processor 304 and the timeslot interchange function 302, the virtual line group digitally emulates a line group. The timeslot interchange function allows the efficient allocation of timeslots for various types of data to various locations.

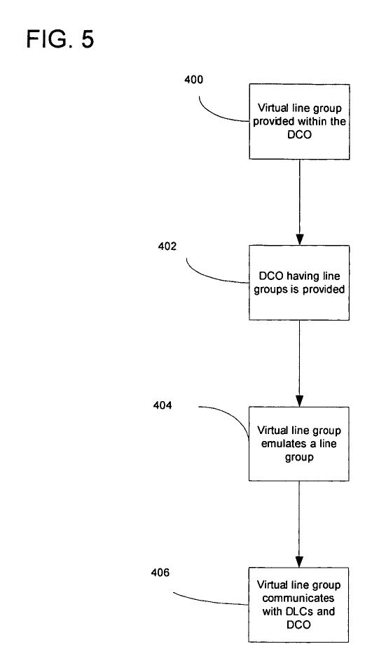

FIG. 5 is a flow chart outlining the steps for digitally emulating a line group in a digital central office according to the teachings of the present invention. With reference to FIGS. 2-5, the steps of the method will now be explained. In step 400, a digital central office 102 having one or more line groups 150 is provided. In step 402, a virtual line group 200 is provided within the digital central office. Next, in step 404, the virtual line group emulates a line group 150. The virtual line group emulates a line group by communicating with components of the digital central office, including the line group highway switch 106, the CMF 108 and the SDLC loop 110. Next, in step 404, the virtual line group communicates with one or more remote DLCs 300 utilizing the GR303 protocol. By emulating a line group, the virtual line group provides a standard GR303 interface without modifying existing digital central office software or hardware.

The present invention may also optionally provide a voice over IP (VOIP) feature to the digital central office. A line card may be added to an existing slot of a line group 150. The line card may run IP phones separate from T1 lines running GR303 protocol.

The present invention enables the addition of GR303 to an existing class 5 digital switch by mimicking one or more analog line groups. The present invention provides the addition of the GR303 functionality without modifying the existing hardware or software of the digital central office. The present invention is an economical add-on GR303 interface for legacy digital central offices. Digital emulation of line groups assures full compatibility with existing and any future digital central office software releases. It should be noted that GR303 is one of several protocols that can be used to operate remote telephones digitally. For example, another protocol is Session Initiation Protocol using a TCP/IP carrier instead of T1's. The virtual line group may convert the internal signals to any other protocols. However, in the preferred embodiment, GR303 is the preferred protocol. The present invention eliminates the expense, floor plan footprint and power required for analog COT's as is required with a double-ended DLC configuration used with an existing digital central office. By utilizing the present invention, switch replacement may be deferred.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A digital emulator for a digital central office, the digital emulator comprising means for digitally emulating a line group within a digital central office.

2. The digital emulator for a digital central office of claim 1 wherein the means for digitally emulating a line group is a virtual line group functioning within a line frame of the digital central office.

3. The digital emulator for a digital central office of claim 2 wherein:
the virtual line group communicates with a common management frame using internal proprietary signals; and
the virtual line group communicates with at least one remote digital loop carrier using a GR303 signaling protocol.

4. The digital emulator for a digital central office of claim 2 wherein the virtual line group provides a GR303 interface between the digital central office and a digital loop carrier.

5. The digital emulator for a digital central office of claim 4 wherein the virtual line group provides the GR303 interface without modifying any hardware or software of the digital central office.

6. The digital emulator for a digital central office of claim 4 wherein the virtual line group includes a timeslot interchange function for communicating with the digital loop carrier.

7. The digital emulator for a digital central office of claim 6 wherein the timeslot interchange function decouples the digital loop carrier from existing line groups of the digital central office.

8. The digital emulator for a digital central office of claim 1 wherein the digital emulator includes a craft management port for communicating with an external computing system.

9. A digital central office having a GR303 interface, the digital central office comprising:
a line frame having a plurality of line groups;
a virtual line group residing within the line frame;
a common management frame communicating with the plurality of line groups and virtual line group using internal proprietary signals; and
at least one digital loop carrier communicating with the virtual line group using a GR303 signaling protocol, the virtual line group providing a GR303 interface for the digital central office.

10. The digital central office having a GR303 interface of claim 9 wherein the virtual line group provides the GR303 interface without modifying any hardware or software of the digital central office.

11. The digital central office having a GR303 interface of claim 9 wherein the virtual line group includes a timeslot interchange function for communicating with the digital loop carrier.

12. The digital central office having a GR303 interface of claim 11 wherein the timeslot interchange function decouples the digital loop carrier from existing line groups of the digital central office.

13. The digital central office having a GR303 interface of claim 9 wherein the virtual line group includes a craft management port for communicating with an external computing system.

14. The digital central office having a GR303 interface of claim 9 further comprising a separate card providing a voice over IP capability to the digital central office.

15. A virtual line group providing a GR303 interface to a digital central office, the virtual line group comprising:
a processor for controlling the virtual line group; and
a timeslot interchange function for communicating with at least one digital loop carrier;
whereby the virtual line group communicates with the digital central office using internal proprietary signals and communicates with the digital loop carrier using a GR303 signaling protocol.

16. The virtual line group of claim 15 wherein the virtual line group is located within a line frame of the digital central office.

17. The virtual line group of claim 15 wherein the virtual line group provides the GR303 interface without modifying any hardware or software of the digital central office.

18. The virtual line group of claim 15 wherein the timeslot interchange function decouples the digital loop carrier from existing line groups of the digital central office.

19. The virtual line group of claim 15 wherein the digital emulator includes a craft management port for communicating with an external computing system.

20. A method of providing a GR303 interface to a digital central office using internal proprietary signals, the method comprising the steps of:
providing a virtual line group to the digital central office, the digital central office having a plurality of existing line groups;
emulating, by the virtual line group, an existing line group within the digital central office; and
communicating with at least one digital loop carrier by the virtual line group using a GR303 signaling protocol.

21. The method of providing a GR303 interface to a digital central office of claim 20 wherein the virtual line group resides in a line frame located with the digital central office.

22. The method of providing a GR303 interface to a digital central office of claim 20 wherein the step of communicating with at least one digital loop carrier includes:
communicating with a common management frame using internal proprietary signals; and
communicating with at least one remote digital loop carrier using the GR303 protocol.

23. The method of providing a GR303 interface to a digital central office of claim 20 wherein the virtual line group provides the GR303 interface without modifying any hardware or software of the digital central office.

24. The method of providing a GR303 interface to a digital central office of claim 20 wherein the virtual line group includes a timeslot interchange function for communicating with the digital loop carrier.

25. The method of providing a GR303 interface to a digital central office of claim 24 wherein the timeslot interchange function decouples the digital loop carrier from existing line groups of the digital central office.

26. The method of providing a GR303 interface to a digital central office of claim 20 further comprising the step of providing a craft management port to the digital central office for communicating with an external computing system.

27. The method of providing a GR303 interface to a digital central office of claim 20 wherein the digital central office includes a class 5 digital switch utilizing internal proprietary signals.
